(19) United States
(12) Patent Application Publication
(10) Pub. No.: US 2019/0168205 A1
(43) Pub. Date: Jun. 6, 2019

(54) Nickel-Containing Yolk-Shell Catalysts

(71) Applicant: UNIVERSITY OF SOUTH CAROLINA, COLUMBIA, SC (US)

(72) Inventors: Erdem Sasmaz, Columbia, SC (US); Jochen Lauterbach, Columbia, SC (US); Sunkyu Kim, Columbia, SC (US)

(21) Appl. No.: 16/136,309

(22) Filed: Sep. 20, 2018

Related U.S. Application Data
(60) Provisional application No. 62/595,152, filed on Dec. 6, 2017.
(60) Provisional application No. 62/623,182, filed on Jan. 29, 2018.

(51) Int. Cl. B01J 35/00; B01J 21/08; B01J 23/83; B01J 35/10; B01J 35/02; C01B 3/40

(52) U.S. Cl. CPC B01J 35/0086; B01J 21/08; B01J 23/83; B01J 35/1061; B01J 35/023; C01B 2203/0261; B01J 35/1019; B01J 35/1023; C01B 3/40; C01B 2203/1058; B01J 35/1014

(57) ABSTRACT

The present disclosure relates to yolk-shell structured catalysts. The yolk-shell catalysts can be particularly useful in the tri-reforming of methane. The yolks can include a primary material (M₁), such as nickel (Ni) or nickel oxide (NiO), and a secondary material (M₂). The shell is generally a porous material that can support the yolk. The shell can include silica (SiO₂) and the secondary material can include ceria (CeO₂). The yolk-shell catalyst can take the form of tube-like structures in which the yolk is dispersed within the shell support in a substantially homogeneous fashion.

### CROSS-REFERENCE TO A RELATED APPLICATION

The present application claims priority to U.S. Provisional Patent Application Ser. No. 62/595,152 titled “Structurally Tunable Highly Active Metal Oxides for Tri-Reforming of Methane” filed on Dec. 6, 2017; and to U.S. Provisional Patent Application Ser. No. 62/623,182 titled “Nickel-Containing Yolk-Shell Catalysts” filed on Jan. 29, 2018, the disclosures of which are incorporated by reference herein.

### FIELD OF THE INVENTION

The present disclosure relates to yolk-shell catalysts. More specifically, the present disclosure relates to yolk-shell catalysts that can be used in the tri-reforming of methane.

### BACKGROUND OF THE INVENTION

Carbon dioxide is a primary greenhouse gas and combustion of fossil fuels is the largest contributor of carbon dioxide emissions. Many concepts, including hydrogenation, reforming, direct conversion via algae, mineralization, photoreduction, electroreduction, co-polymerization, as well as tri-reforming processes have been proposed for reducing carbon dioxide emissions. However, to date, there has not been wide deployment of tri-reforming technology.

Catalytic tri-reforming is a unique process that can use carbon dioxide emissions directly from a combustion source, such as a coal or natural gas power plant, using natural gas as the primary reactant. The tri-reforming reaction involves a synergetic combination of dry reforming (DR), steam reforming (SR), and partial oxidation of methane (POM). In the tri-reforming process, most of the carbon dioxide content of the power plant flue gas can be converted to syngas (a mixture gas consisting of carbon monoxide and hydrogen) by dry reforming. Dry reforming produces H₂/CO molar ratios of 1, which can be used for production of liquid hydrocarbons and oxygenates. Coupling DR, SR, and POM can advantageously provide for the adjustment of H₂/CO molar ratios between 1 and 2.5. In such a combined process, carbon dioxide emissions from a power plant can be utilized to produce syngas with a suitable H₂:CO ratio for Fischer-Tropsch methanol and dimethyl ether (DME) synthesis.

The lack of tri-reforming technology implementation can be accounted for, at least in-part, by the need for robust catalysts that can withstand harsh operating conditions and are resistant to coke-fouling and sintering. The present disclosure introduces robust and efficient catalysts that can be used in the tri-reforming of methane.

### BRIEF SUMMARY OF THE INVENTION

Aspects and advantages of embodiments of the present disclosure will be set forth in part in the following description, or may be learned from the description, or may be learned through practice of the embodiments.

Embodiments of the present disclosure include yolk-shell structured catalysts. The yolk can include a primary material (M₁), such as nickel (Ni) or a metal oxide such as nickel oxide (NiO), and a secondary material (M₂). The shell is generally a porous material that can support the yolk and can include silica (SiO₂). The secondary material can include cerium. In one particular embodiment, the secondary material can be ceria (CeO₂), which is an oxide of cerium. The yolk-shell catalyst can take the form of tube-like structures (e.g., nanotubes) in which the yolk is dispersed within the shell support in a substantially homogeneous fashion. In one particular embodiment, the shell can include silica (SiO₂).

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

FIG. 1 is an image of a yolk-shell catalyst according to an embodiment of the present disclosure.

FIG. 2 illustrates a method of forming yolk-shell catalysts of the present disclosure.

FIG. 3 illustrates the chemical reactions involved in the tri-reforming process.

FIG. 4(A) illustrates the particle size distribution of yolk-shell catalysts formed with a water to cetrimonium bromide (CTAB) molar ratio (water/CTAB) of 12.6.

FIG. 4(B) illustrates the particle size distribution of yolk-shell catalysts formed with a water to cetrimonium bromide (CTAB) molar ratio (water/CTAB) of 18.9.

FIG. 5(A) is an image of yolk-shell catalysts formed using a reverse microemulsion method with a water/CTAB ratio of 12.6.

FIG. 5(B) is an image of yolk-shell catalysts formed using a reverse microemulsion method with a water/CTAB ratio of 18.9.

FIG. 5(C) is an image of catalysts formed using a wet impregnation fabrication method.

FIG. 6(A) shows the tri-reforming conversion percentages of various catalysts over time [(CH₄:CO₂:H₂O:O₂=2:1:1:0.2); gas hourly space velocity (GHSV)=60,000 ml/(g·h); tri-reforming reaction performed at 750° C.].

FIG. 6(B) shows the tri-reforming conversion percentages of various catalysts over time [(CH₄:CO₂:H₂O:O₂=2.2:1:1:0.2); gas hourly space velocity (GHSV)=60,000 ml/(g·h); tri-reforming reaction performed at 750° C.].

### DETAILED DESCRIPTION OF THE INVENTION

Aspects and advantages of embodiments of the present disclosure will be set forth in part in the following description, or may be learned from the description, or may be learned through practice of the embodiments.

The present disclosure is directed toward yolk-shell structured catalysts. The yolk-shell structures can be used to facilitate various reactions including the tri-reforming of methane. The yolks can include a primary material (M₁), such as nickel (Ni), and a secondary material (M₂). The secondary material can include, for example, cerium. The shell is generally a porous material that can support the yolks. The yolk-shell catalyst can take the form of spherical or tube-like structures in which the yolk is dispersed within the shell support in a substantially homogeneous fashion.

The tri-reforming process requires catalyst formulations to withstand high reaction temperatures and coke formation. Specifically, coke formation is a severe problem at some feed gas compositions, such as high methane to oxidizer ratios. Deposited coke blocks the surface of active materials required for the reaction and decreases the catalyst life substantially. At high reaction temperatures, catalysts of the prior art can be deactivated by sintering and agglomeration. Therefore, lower reaction temperatures are needed, but this reduces the activity of the catalysts.

The present disclosure teaches novel yolk-shell structures that can overcome these challenges of the prior art. Catalysts of the present disclosure can withstand harsh conditions, avoid coke fouling, and operate for long periods without significant performance degradation. In the yolk-shell structure, the catalyst yolks (or cores) are formed of an active catalytic material, which is surrounded by a porous shell material support. This unique morphology provides increased catalyst stability under reaction conditions, and disperses and stabilizes the active yolk materials.

The enhanced stability of the yolk-shell structures can be explained by their distinctive morphology, at least in part. The morphology of the yolk-shell catalyst is also tunable, which makes the yolk-shell catalysts easily adaptable to other reactions. For example, the yolk-shell catalysts can be used as a fuel processor in solid oxide and molten carbonate fuel cells for electricity generation. Other applications include catalytic processes that have difficulty with catalyst deactivation through coke formation and high temperatures.

The yolk-shell catalysts of the present disclosure have been found to be particularly effective in converting carbon dioxide to syngas. This can be applied to the directly in fossil-fuel-fired power plants where carbon dioxide would otherwise be released to the atmosphere. The production of syngas can be accomplished using natural gas in a tri-reforming process. The catalyst is designed to operate at harsh reaction conditions and has been shown to have high carbon dioxide conversion efficiency. The unique structure of the catalyst provides excellent tri-reforming activity and long catalyst life. Further, the metals used to form the catalysts of the present disclosure are less costly than precious metals. The cost of the microemulsion methods described herein are also comparable to or less expensive than methods of the prior art, such as co-precipitation and wet impregnation.

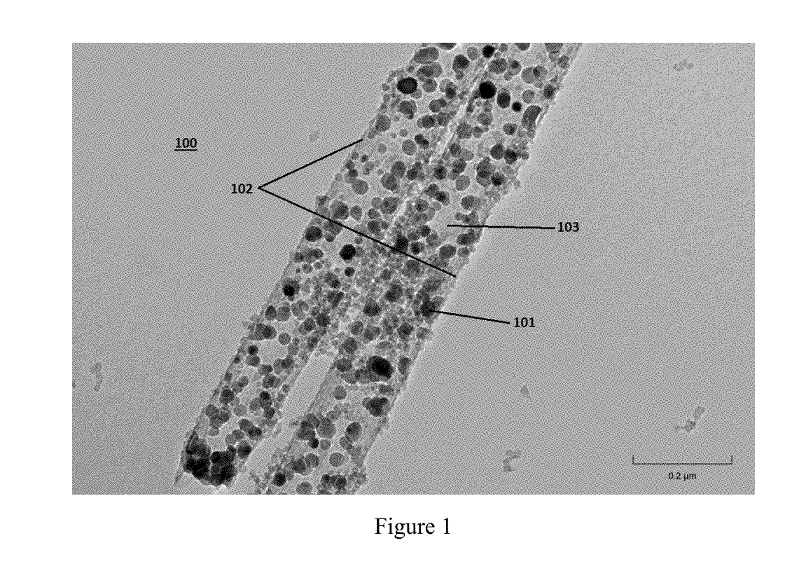

FIG. 1 shows an image of yolk-shell catalysts according to an embodiment of the present disclosure. According to an embodiment, a yolk-shell structured catalyst 100 can include one or more yolks 101 within a shell 102. FIG. 1 shows multiple yolks 101 that are supported by a porous shell 102. The yolks 101 are darkly shaded and are distributed in a substantially homogenous fashion throughout the shell support 102. The yolk-shell structured catalyst 100 can also include gaps (or voids) 103. The gaps 103 within the yolk-shell structured catalyst 100 can promote the flow of reactants within the catalyst structures.

The porous shell 102 allows for reactants to penetrate the shell 102 and reach the yolks 101, which are the active sites of catalysis. The porous shell 102 also keeps coke formation from blocking the catalytically active yolks 101. The yolks 101 can include a primary material (M₁) and a secondary material (M₂). The primary material (M₁) can be a metal and can include one or more of nickel (Ni), cobalt (Co), gold (Au), silver (Ag), copper (Cu), palladium (Pd), platinum (Pt), iron (Fe), ruthenium (Ru), rhodium (Rh), iridium (Ir), and osmium (Os). In one preferred embodiment, the primary material includes nickel (Ni) and/or nickel oxide (NiO). The secondary material (M₂) can include one or more of cerium (Ce), lithium (Li), sodium (Na), cesium (Cs), magnesium (Mg), calcium (Ca), titanium (Ti), zirconium (Zr), vanadium (V), yttrium (Y), manganese (Mn), rhenium (Re), gallium (Ga), germanium (Ge), tin (Sn), indium (In), cobalt (Co), gold (Au), silver (Ag), copper (Cu), platinum(Pt), ruthenium (Ru), rhodium (Rh), iridium (Ir), osmium (Os), palladium (Pd), and iron (Fe). In one preferred embodiment, the secondary material (M₂) includes ceria (CeO₂). The shell can include a porous ceramic such as silica (SiO₂).

The weight of the yolks 101 of the yolk-shell catalyst 100 can range from about 0.1 wt. % to about 40 wt. % of the total weight of the yolk-shell catalysts, such as from about 8 wt. % to about 22 wt. % of the catalyst, and such as from about 12 wt. % to about 18 wt. % of the catalyst. The weight of the primary material (M₁) can account for from about 0.1 wt. % to about 30 wt. % of the catalyst, such as from about 7 wt. % to about 13 wt. % of the catalyst, and such as from about 8.5 wt. % to about 11.5 wt. % of the catalyst. The secondary material (M₂) can account for from about 0.1 wt. % to about 10 wt. % of the catalyst, such as from about 2 wt. % to about 8 wt. % of the catalyst, and such as from about 3.5 wt. % to about 6.5 wt. % of the catalyst. The yolk-shell catalysts 100 can be formed by a reverse microemulsion process.

The yolk-shell catalyst 100 can be porous in structure, allowing reactants to reach the reactive yolks 101 that are housed within the shell 102. The pore sizes of the yolk-shell catalyst 100 can be controlled. For example, the catalyst can have pore sizes ranging from about 5 nm to about 30 nm in diameter, such as from about 10 nm to about 25 nm in diameter. The yolk-shell catalyst 100 can take multiple forms including spherical particles and tube-shaped particles. When the yolk-shell particles are spherical, the spherical catalyst particles can have an average diameter ranging from about 5 nm to about 500 nm, such as from about 10 nm to about 130 nm.

The tube-shaped particles can provide for more surface area and make it easier for reactants to penetrate the shell 102 and reach the yolks 101. Methods of the present invention allow for the length and diameter of the tube-shaped catalysts to be controlled. For example, the tube-shaped yolk-shell catalysts can have an average diameter ranging from about 5 nm to about 800 nm, such as from about 10 nm to about 300 nm, and such as from about 15 nm to about 100 nm. The average length of the tube-shaped particles can be from about 0.1 μm to about 5 μm, such as from about 0.3 μm to about 3 μm, and such as from about 0.8 μm to about 1.5 μm. Further, the tubular catalyst particles can have an aspect ratio (length/diameter) of from about 2 to about 50, such as from about 3 to about 20, and such as from about 5 to about 10.

The surface area of the yolk-shell catalyst can also be tuned using the reverse microemulsion process. For example, the yolk-shell catalyst can have a surface area of from about 30 m²/g to about 600 m²/g, such as from about 150 m²/g to about 500 m²/g, and such as from about 250 m²/g to about 450 m²/g. The size of the individual yolks 101 within the yolk-shell catalyst 100 can also be controlled. For example, the average diameter of the individual yolks can range from about 1 nm to about 100 nm, such as from about 10 nm to about 50 nm, and such as from about 20 nm to about 40 nm.

The yolk-shell catalysts can be formed using a reverse microemulsion process. The microemulsions of the present invention are thermodynamically stable and occur spontaneously. Thus, minimal to no work input is required to form the microemulsions. The length of the yolk-shell structures can be controlled by aging the solution during synthesis. The width of the tube-like structures can be tuned by adjusting the water to surfactant ratio. The concentration of the metal precursor can be adjusted to produce either tube-like or spherical catalyst structures. The structures can also be obtained in core-shell form, in which the core and shell are in close interaction and gaps or voids are reduced or eliminated.

The reverse microemulsion method of forming the yolk-shell catalysts can include forming a yolk mixture by mixing a precursor primary material aqueous solution (e.g., a nickel aqueous solution), a secondary material aqueous solution, and a surfactant in a non-aqueous solvent. For example, the primary material aqueous solution can include a nickel nitrate solution, the secondary material solution can include a cerium nitrate solution, and the surfactant can include cetrimonium bromide (CTAB). The non-aqueous solvent can be non-polar such that the aqueous yolk mixture forms discrete domains within the non-polar solvent. For example, the non-aqueous solvent can include butanol and/or cyclohexane. Forming the yolk mixture can also include adding an ammonia solution to the yolk mixture and heating.

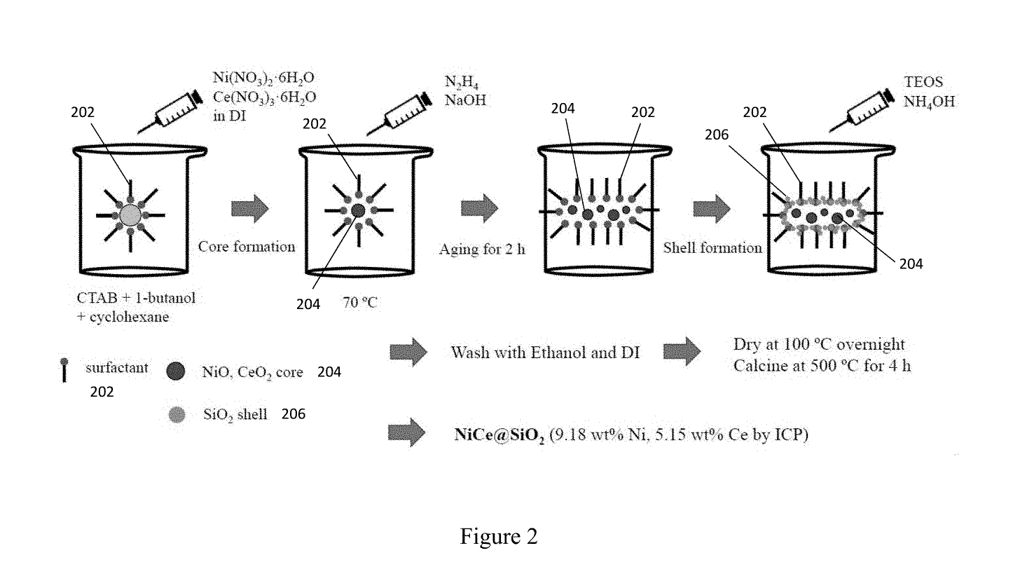

A yolk-shell mixture can then be formed by adding a silica precursor solution to the yolk mixture. For example, the silica precursor can include tetraethyl orthosilicate (TEOS). Adding the silica precursor to the yolk mixture allows for the formation of the yolk-shell catalyst structures within the non-polar solvent. The formation of the yolk-shell structures within the discrete domains of the non-aqueous solvent is facilitated by the surfactant. After the yolk-shell catalyst structures are allowed to form in the yolk-shell mixture, the yolk-shell mixture can be dried and then calcinated. FIG. 2 shows a specific example of a reverse microemulsion process for forming yolk-shell catalyst structures of the present disclosure, which will be further discussed in Example 1, below.

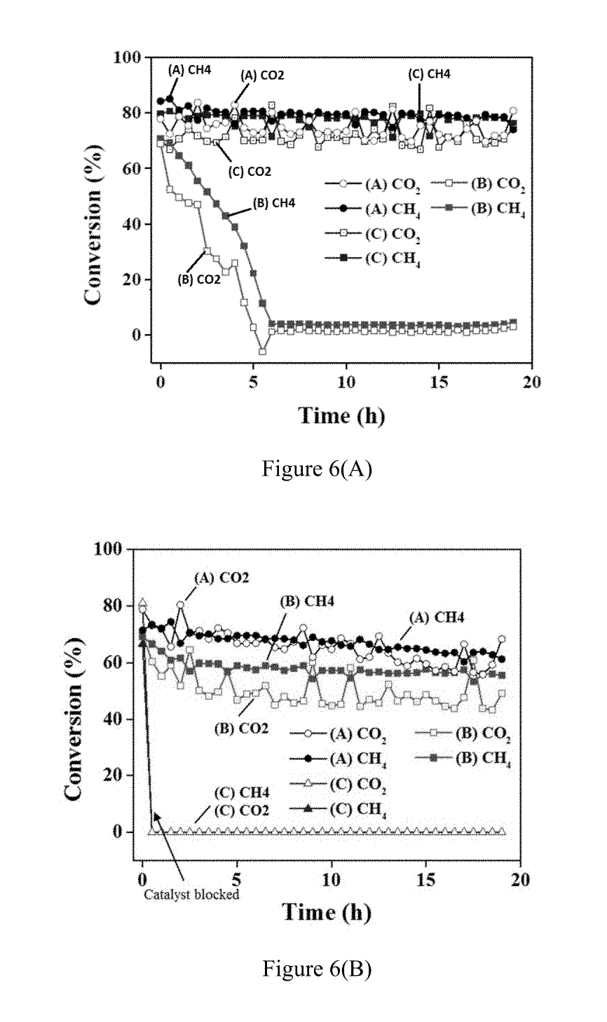

Yolk-shell catalysts of the present disclosure can be employed for tri-reforming of methane processes. Conversion rates of methane can range from about 70% to about 99%, such as from about 75% to about 85% (FIG. 6(A)). Conversion rates of carbon dioxide can range from about 65% to about 99%, such as from about 70% to about 80% (FIG. 6(A)). Catalysts of the present disclosure can achieve higher conversion efficiencies than those of the prior art, particularly under high methane to oxidizer ratios.

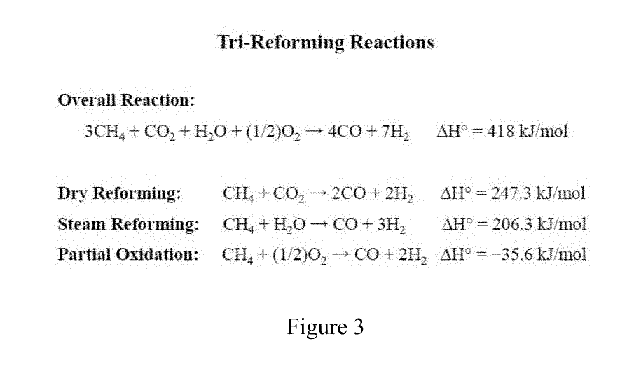

Catalytic tri-reforming can use carbon dioxide (CO₂) emissions directly from a combustion source, such as a coal or natural gas power plant, using natural gas (methane) as a primary reactant. FIG. 3 illustrates the chemical reactions involved in the tri-reforming process. The tri-reforming reaction involves a synergetic combination of dry reforming (DR), steam reforming (SR), and partial oxidation of methane (POM). In the tri-reforming process, most of the CO₂ content of the power plant flue gas can be converted to syngas (a mixture gas consisting of carbon monoxide (CO) and hydrogen (H₂)) by DR. Dry reforming produces H₂/CO molar ratios of 1, which can be used for production of liquid hydrocarbons and oxygenates. Coupling DR, SR, and POM can provide the advantage be being able to adjust the H₂/CO molar ratios between 1 and 2.5. In such a combined process, CO₂ emissions from a power plant can be utilized to produce syngas with a suitable H₂:CO ratio for Fischer-Tropsch, methanol and dimethyl ether (DME) synthesis.

The tri-reforming reaction temperature can range from about 600° C. to about 850° C., such as from about 700° C. to about 825° C., and such as from about 750° C. to about 800° C. The gas composition going into the tri-reforming reactor can range from about 10 wt. % to about 40 wt. % methane, from about 5 wt. % to about 15 wt. % carbon dioxide, from about 5 wt. % to about 20 wt. % water, and from about 0.5 wt. % to about 5 wt. % oxygen. More specifically, the gas composition going into the tri-reforming reactor can range from about 15 wt. % to about 30 wt. % methane, from about 7 wt. % to about 13 wt. % carbon dioxide, from about 7 wt. % to about 15 wt. % water, and from about 1 wt. % to about 3 wt. % oxygen. Even more specifically, the gas composition going into the tri-reforming reactor can range from about 20 wt. % to about 25 wt. % methane, from about 8 wt. % to about 10 wt. % carbon dioxide, from about 10 wt. % to about 13 wt. % water, and from about 1.5 wt. % to about 2 wt. % oxygen.

The tri-reforming process requires catalyst formulations to withstand high reaction temperatures and coke formation. Coke formation is a severe problem at certain feed gas compositions, such as high methane to oxidizer ratios. Deposited coke blocks the surface of active materials required for the reaction and decreases the catalyst life substantially. At high reaction temperatures, catalysts of the prior art are deactivated due to sintering and/or agglomeration. Therefore, lower reaction temperatures are desired, but lower reaction temperatures lower catalyst carbon dioxide reactivity. Catalysts of the present disclosure can overcome these challenges by avoiding coke fouling event at reaction temperatures greater than 600° C.

### EXAMPLE 1

FIG. 2 illustrates an example method of forming yolk-shell catalysts according to an embodiment of the present disclosure. Nickel nitrate, cerium nitrate, and cetrimonium bromide (CTAB) surfactant 202 were mixed with 1-butanol and cyclohexane to form a yolk mixture. Time (approximately an hour) was allowed for yolks (or cores) to form in the yolk mixture. Hydrazine (N₂H₄) and sodium hydroxide (NaOH) were added to the yolk mixture and the yolk mixture was heated to 70° C. and allowed to set for approximately 2 hours.

Tetraethyl orthosilicate (TEOS) and ammonium hydroxide (NH₄OH) were added to the yolk mixture to form a yolk-shell mixture. The TEOS acted as the silica source and allowed the silica to form a shell 206 that supported the nickel and cerium core or yolks 204. After the yolk-shell catalyst structures were allowed to form, the yolk-shell mixture was washed with DI water and ethanol and then dried overnight at a temperature of 100° C. The dried yolk-shell catalyst was then calcinated for 4 hours at 500° C. The nickel and cerium content within the catalyst was determined to be 9.18 wt. % and 5.15 wt. % of the total weight of the catalyst, respectively.

### EXAMPLE 2

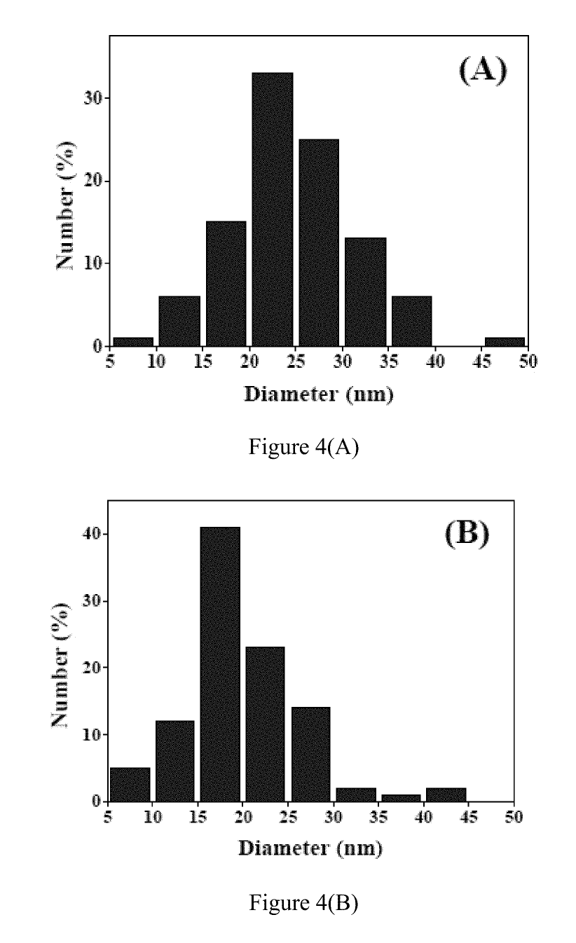

The yolk-shell catalysts of EXAMPLE 1 were fabricated and their properties determined. FIGS. 4(A) and 4(B) illustrate the particle size distribution of yolk-shell catalysts formed with a water to cetrimonium bromide (CTAB) molar ratio (water/CTAB) of (A) 12.6 and (B) 18.9. FIGS. 4(A) and 4(B) show that yolk-shell catalysts synthesized with a higher surfactant concentration have narrower tube width, larger yolk particle size, and a higher surface area. Table 1, below, lists the water to CTAB molar ratios, the average tube width, average particle size, and average surface area of the yolk-shell catalysts.

TABLE 1
Synthesizing Parameters and Properties of Yolk-Shell Catalysts

| | Water/CTAB | Tube Width | Particle Size | Surface Area |
|---|---|---|---|---|
| | (mol ratio) | (nm) | (nm) | (m²/g) |
| (A) | 12.6 | 125.5 | 24.8 | 400.3 |
| (B) | 18.9 | 176.1 | 20.0 | 366.9 |

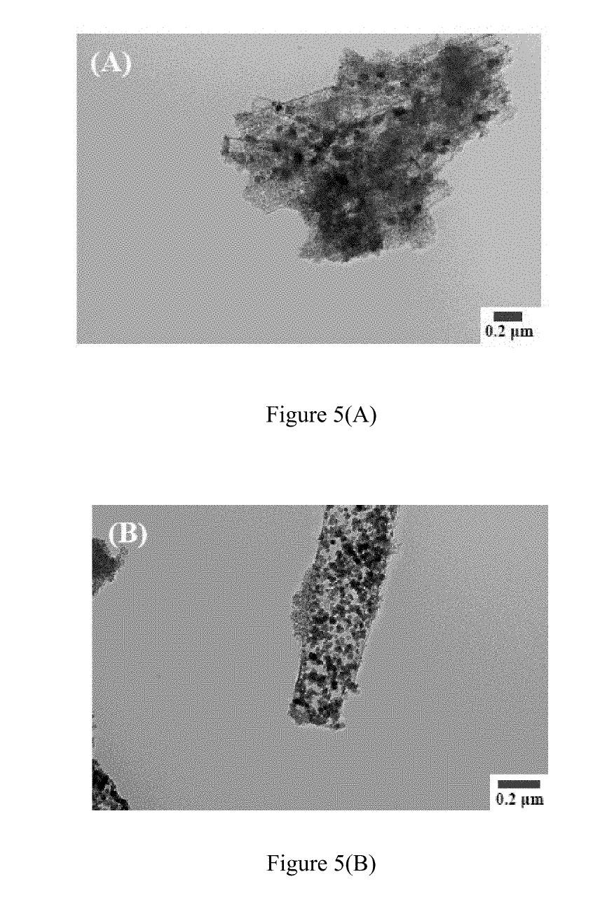

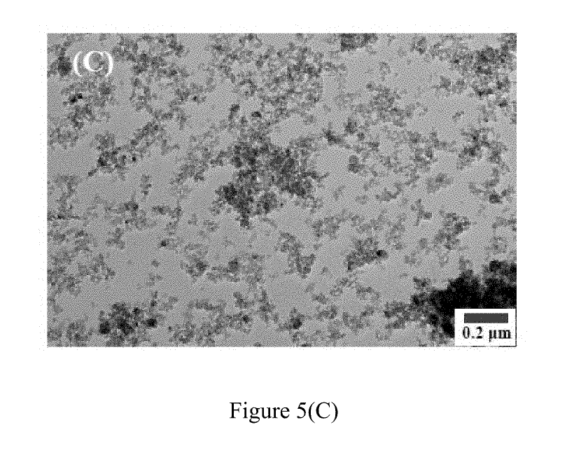

FIG. 5(A) is an image of the yolk-shell catalysts formed using a reverse microemulsion method with a water/CTAB ratio of 12.6 (i.e., “catalyst A”). FIG. 5(B) is an image of the yolk-shell catalysts formed using a reverse microemulsion method with a water/CTAB ratio of 18.9 (i.e., “catalyst B”). FIG. 5(C) is an image of NiCe/SiO₂ catalysts formed using a wet impregnation fabrication method (i.e., “catalyst C”). The catalysts of FIGS. 5(A), 5(B), and 5(C) had nickel and cerium content of about 9 wt. % and about 5 wt. %, respectively.

FIG. 6(A) shows the corresponding tri-reforming conversion percentages of the catalysts of FIGS. 5(A), 5(B), and 5(C). The tri-reforming process was carried out at 750° C. The molar ratios of the feed gas for each of the tests was CH₄:CO₂:H₂O:O₂=2:1:1:0.2. The gas hourly space velocity (GHSV) during the experiments was 60,000 ml/(g·h). In one experiment, for example, the conversion rates were 79% for methane and 75% for carbon dioxide, with a hydrogen selectivity of 96% and hydrogen to carbon dioxide ratio (H₂/CO) of 1.7.

FIG. 6(A) shows that catalyst A and wet impregnation catalyst C had conversion rates of approximately 80% over the 20 hour testing period. FIG. 6(A) also shows that the yolk-shell catalyst formed at lower concentration of CTAB (catalyst B) began with conversation rates of approximately 75%, but the conversion rate quickly dropped to around 2%. This drop in conversion efficiency was likely due to the collapse and oxidation of the catalyst at a low methane to oxidizer feed ratio.

FIG. 6(B) shows the corresponding tri-reforming conversion percentages of the catalysts of FIGS. 5(A), 5(B), and 5(C). The molar ratios of the feed gas for each of the tests was CH₄:CO₂:H₂O:O₂=2.2:1:1:0.2. The gas hourly space velocity (GHSV) during the experiments was 60,000 ml/(g·h). FIG. 6(B) shows that yolk-shell catalyst A had slightly higher conversion percentages than yolk-shell catalyst B, which had higher conversion rates than the wet impregnation catalyst C.

Catalysts A and B showed a slight reduction in efficiency over time which appeared to level off after 20 hours. In contrast, catalyst C began with similar conversion rates of approximately 80%, but then the conversion rate of catalyst C plummeted after approximately 1 hour. The severe drop in the conversion efficiency of catalyst C was likely due to coke fouling (i.e., coke blocking access to the active nickel/cerium sites on the catalyst) at a high methane to oxidizer feed ratio. The lattice parameters of catalysts A, B, and C are summarized in Table 2.

TABLE 2
Catalyst Lattice Parameters

| | | (A) | (B) | (C) |
|---|---|---|---|---|
| NiO (111) | Size (nm) | 18.7 | 15.9 | 13.0 |
| | Lattice Constant (Å) | 4.14 | 4.15 | 4.16 |
| CeO₂ (111) | Size (nm) | 5.9 | 7.9 | 3.9 |
| | Lattice Constant (Å) | 5.30 | 5.34 | 5.38 |

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A yolk-shell structured catalyst for tri-reforming of methane comprising:
a yolk including a primary material (M₁) and a secondary material (M₂); and
a porous shell support that encapsulates the yolk.

2. The catalyst of claim 1, wherein the primary material (M₁) includes nickel (Ni) or nickel oxide.

3. The catalyst of claim 1, wherein the secondary material includes cerium (Ce), palladium (Pd), or iron (Fe).

4. The catalyst of claim 1, wherein the secondary material includes ceria (CeO₂).

5. The catalyst of claim 1, wherein the porous shell support includes silica (SiO₂).

6. The catalyst of claim 1, wherein nickel comprises from 0.1 wt. % to 30 wt. % of the catalyst.

7. The catalyst of claim 1, wherein the secondary material comprises from 0.1 wt. % to 10 wt. % of the catalyst.

8. The catalyst of claim 1, wherein the catalyst is produced using a reverse microemulsion process.

9. The catalyst of claim 1, wherein the catalyst has pores ranging from about 5 nm to about 30 nm in diameter.

10. The catalyst of claim 1, wherein the catalyst is in the form of spherical particles.

11. The catalyst of claim 10, wherein the spherical particles have an average diameter of from about 10 nm to about 500 nm.

12. The catalyst of claim 1, wherein the catalyst is in the form of tubular particles.

13. The catalyst of claim 12, wherein the tubular particles have an average diameter of from about 10 nm to about 300 nm.

14. The catalyst of claim 12, wherein the tubular particles have an average length of from about 0.1 μm to about 5 μm.

15. The catalyst of claim 12, wherein the tubular particles have an aspect ratio (length/diameter) of from about 2 to about 50.

16. The catalyst of claim 1, wherein the catalyst has a surface area of from about 30 m²/g to about 600 m²/g.

17. The catalyst of claim 1, wherein multiple yolks exist within the shell and each of the yolks has a diameter ranging from 10 nm to 40 nm.

18. A tri-reforming methane method comprising contacting methane, carbon dioxide, water, and oxygen with the catalyst of claim 1.

19. The tri-reforming methane method of claim 18, wherein the reactants include from about 10 wt. % to about 40 wt. % methane, from about 5 wt. % to about 15 wt. % carbon dioxide, from about 5 wt. % to about 20 wt. % water, and from about 0.5 wt. % to about 5 wt. % oxygen.

20. A reverse microemulsion method of fabricating yolk-shell catalysts comprising:
forming a yolk mixture by mixing a precursor nickel aqueous solution, a secondary material aqueous solution, and a surfactant in a non-aqueous solvent;
adding a base to the yolk mixture, heating the yolk mixture, and allowing yolks to form within the yolk mixture;
adding a silica precursor to the yolk mixture to form a yolk-shell mixture;
drying the yolk-shell mixture; and
calcinating the yolk-shell mixture to produce the yolk-shell catalyst.

21. The reverse microemulsion method of fabricating yolk-shell catalysts of claim 20, further comprising adding a polymerizing agent to the yolk mixture.

22. The reverse microemulsion method of fabricating yolk-shell catalysts of claim 20, wherein the nickel aqueous solution is a nickel nitrate solution.

23. The reverse microemulsion method of fabricating yolk-shell catalysts of claim 20, wherein the secondary material solution is a cerium nitrate solution.

24. The reverse microemulsion method of fabricating yolk-shell catalysts of claim 20, wherein the surfactant includes cetrimonium bromide (CTAB).

25. The reverse microemulsion method of fabricating yolk-shell catalysts of claim 20, wherein the non-aqueous solvent includes butanol and cyclohexane.

26. The reverse microemulsion method of fabricating yolk-shell catalysts of claim 20, wherein the silica precursor includes tetraethyl orthosilicate (TEOS).

27. The reverse microemulsion method of fabricating yolk-shell catalysts of claim 20, further comprising adding an ammonia solution to the yolk mixture.
